(19) United States
(12) Patent Application Publication
(10) Pub. No.: US 2007/0230635 A1
(43) Pub. Date: Oct. 4, 2007

(54) WIRELESS COMMUNICATION RECEPTION WITH COOPERATION BETWEEN AGC AND DIGITAL BASEBAND

(76) Inventors: Leif Wilhelmsson, Dalby (SE); Jim Svensson, Ronneby (SE); Lars Sundstrom, Lund (SE)

Correspondence Address: ERICSSON INC., 6300 LEGACY DRIVE, M/S EVR 1-C-11, PLANO, TX, 75024, US

(21) Appl. No.: 11/278,527

(22) Filed: Apr. 3, 2006

(51) Int. Cl. H04L 27/08; H04K 1/10

(52) U.S. Cl. 375/345; 375/260

(57) ABSTRACT

In communication systems where the channel is expected to vary during a communication burst, gain adjustments during the communication burst can be implemented by automatic gain control (AGC) in the receiver, with minimal performance degradation. These gain adjustments are successfully accommodated by virtue of suitable information-sharing between an AGC unit and a digital baseband part. The digital baseband part can direct the AGC unit appropriately to ensure that gain adjustments are implemented during time intervals that do not carry substantive communication information (e.g., guard intervals). In receivers that perform channel estimation in the digital baseband part, the AGC unit supports channel estimation by informing the digital baseband part about the timing of the gain adjustment. The AGC unit can also support channel estimation by informing the digital baseband part about the size of the gain adjustment.

### TECHNICAL FIELD

The invention relates generally to wireless communication and, more particularly, to automatic gain control (AGC) and channel estimation in wireless communications.

### BACKGROUND OF THE INVENTION

The following documents are incorporated herein by reference:
[1] ETSI EN 300 744 V.1.4.1 (2001-01), Digital Video Broadcast (DVB); Framing structure, channel coding and modulation for digital terrestrial television.
[2] ETSI EN 302 304 v1.1.1 (2004-11), Digital Video Broadcasting (DVB), Transmission System for Handheld Terminals (DVB-H).

Many conventional wireless communication systems use automatic gain control (AGC) to handle large variations in received power levels. The use of AGC can, among other things, permit the receiver to minimize the number of bits needed in the analog-to-digital converter (ADC). In applications where the communication information is transmitted in short intervals in time, sometimes referred to as bursts, the AGC can implement gain changes between the bursts.

Channel estimation is another common function in conventional systems. Conventional channel estimation can include operations such as estimating the phase and amplitude for each path, or estimating the impulse response of the channel in the time domain. In conventional OFDM (Orthogonal Frequency Division Multiplexing) systems, channel estimation is often performed in the frequency domain. The transfer function of the channel is determined in the frequency domain by estimating the phase and the amplitude on a plurality of frequencies within the occupied bandwidth. In OFDM systems such as DVB-T (Digital Video Broadcasting—Terrestrial) and DVB-H (Digital Video Broadcasting—Handheld) systems as described by the standard “ETSI EN 300 744 V.1.4.1 (2001-01), Digital Video Broadcast (DVB); Framing structure, channel coding and modulation for digital terrestrial television” and “ETSI EN 302 304 v1.1.1 (2004-11), Digital Video Broadcasting (DVB); Transmission System for Handheld Terminals (DVB-H)”, respectively, the channel is often estimated in the frequency domain at the receiver using known pilot symbols. For example, and with reference to the time (t)-frequency (f) grid shown in FIG. 1, it is common to estimate the channel in the following three steps: (1) estimate the channel wherever pilot symbols (shaded in FIG. 1) occur in the time-frequency grid; (2) for each frequency that carries scattered pilot symbols, interpolate in the time direction between the channel estimates that were produced from the scattered pilots, thereby resulting in channel estimates for all symbols on every third frequency carrier; and (3) interpolate in the frequency direction to produce channel estimates for all symbols in the time-frequency grid.

In systems such as IEEE 802.11 systems and GSM systems, the communication information is transmitted in bursts that are typically short enough to avoid problems associated with tracking channel variations. Due to the short burst duration in these systems, the channel can be assumed to remain unchanged during the burst. Under this assumption, there is no need for the AGC to vary the gain during the burst; it is enough to vary the gain between the bursts.

Other conventional systems use continuous transmissions, so the aforementioned unchanging channel assumption is inapplicable. Still other systems use bursts that are long enough to invalidate any assumption that the channel remains unchanged throughout the burst. For example, in the DVB-H standard, the time slice (i.e., burst) duration can be expected to be on the order of 200-400 ms. The channel can therefore be expected to vary during the burst. This variation of the channel during the burst can also mean the AGC will need to adjust the gain during the burst. However, a gain adjustment by the AGC during the burst can degrade performance. For example, in OFDM systems that use an FFT (Fast Fourier Transform) of size N, the effective duration of a symbol is N times the nominal symbol duration. If the AGC adjusts the gain during the part of the symbol that is used by the FFT in the OFDM receiver, this causes a loss of orthogonality between subcarriers. This loss of orthogonality between subcarriers results in severe performance degradation due to ICI (Inter Carrier Interference).

It is desirable in view of the foregoing to provide for controlling AGC gain adjustment to avoid unacceptable performance degradation in wireless communication systems (such as OFDM systems) where the channel is not expected to remain unchanged between channel estimates.

### SUMMARY

In communication systems where the channel is not expected to remain unchanged throughout a communication burst, gain adjustments during the communication burst can be implemented by automatic gain control (AGC) in the receiver, without unacceptable performance degradation. These gain adjustments are successfully accommodated by virtue of suitable information-sharing between an AGC unit and a digital baseband part. The digital baseband part can direct the AGC unit appropriately to ensure that gain adjustments are implemented during time intervals that do not carry substantive communication information (e.g., guard intervals). In receivers that perform channel estimation in the digital baseband part, the AGC unit supports channel estimation by informing the digital baseband part about the timing of the gain adjustment. The AGC unit can also support channel estimation by informing the digital baseband part about the size of the gain adjustment.

In some embodiments, an apparatus for use in a communication receiver includes an input for receiving a communication signal from a communication channel, an AGC apparatus coupled to the input and configured to apply a gain adjustment to the communication signal to produce a gain adjusted communication signal, an analog-to-digital converter (ADC) coupled to the AGC apparatus for converting the gain adjusted communication signal into a digital signal, and a digital baseband part coupled to receive the digital signal from the ADC. The AGC apparatus is coupled to the digital baseband part and configured to receive from the digital baseband part an indication of an adjustment time at which the gain adjustment is permitted. The AGC apparatus is configured to apply the gain adjustment to the communication signal at the adjustment time in response to the indication.

In some embodiments, an apparatus for use in a communication receiver includes an input for receiving a communication signal from a communication channel, an AGC apparatus coupled to the input and configured to apply a gain adjustment to the communication signal to produce a gain adjusted communication signal, an ADC coupled to the AGC apparatus for converting the gain adjusted communication signal into a digital signal, and a digital baseband part coupled to receive the digital signal from the ADC. The digital baseband part includes a channel estimator coupled to receive from the AGC apparatus timing information indicative of when the gain adjustment occurs. The channel estimator is configured to estimate the communication channel based on the digital signal, the timing information, and size information indicative of a size of the gain adjustment.

In some embodiments, a method for use in a communication receiver includes receiving a communication signal from a communication channel, using AGC to apply a gain adjustment to the communication signal to produce a gain adjusted communication signal, and receiving an indication of an adjustment time at which digital baseband operation permits the gain adjustment. In response to the indication, the gain adjustment is applied to the communication signal at the adjustment time. The gain adjusted communication signal is converted into a digital signal for use in digital baseband operation.

### BRIEF DESCRIPTION OF THE DRAWINGS

FIG. 1 illustrates an example of placement of pilot symbols in the time-frequency grid of an OFDM communication system;

FIG. 2 graphically illustrates effective SNR versus AGC gain step, where the gain step occurs in the middle of an OFDM symbol;

FIG. 2A graphically illustrates effective SNR versus the position of the AGC gain step in an OFDM symbol;

FIG. 3 diagrammatically illustrates an OFDM communication system according to the prior art;

FIG. 4 is a timing diagram, which illustrates a timing relationship between guard intervals and information carrying intervals;

FIG. 5 graphically illustrates an example of a channel estimation error that can occur because of an AGC gain adjustment;

FIG. 6 diagrammatically illustrates a communication receiver apparatus wherein a digital baseband part cooperates with an AGC unit to implement channel estimation that compensates for AGC gain adjustments, according to embodiments of the invention;

FIG. 6A is a flow chart illustrating the general steps of operation of embodiments of the invention;

FIG. 7 diagrammatically illustrates a communication receiver apparatus wherein the digital baseband part cooperates with the AGC unit to estimate AGC gain adjustments and implement channel estimation that compensates for the estimated adjustments, according to embodiments of the invention;

FIG. 8 illustrates operations for digital baseband estimation of AGC gain adjustments according to an embodiment of the invention;

FIG. 9 illustrates further operations for digital baseband estimation of AGC gain adjustments according to embodiments of the invention;

FIG. 10 graphically illustrates, for a 2-tap interpolation filter, examples of loss versus Doppler frequency associated with different errors in estimating an AGC gain adjustment that occurs at the middle of the interpolation filter;

FIG. 11 graphically illustrates, for a 4-tap interpolation filter, examples of loss versus Doppler frequency associated with different errors in estimating an AGC gain adjustment that occurs at the middle of the interpolation filter;

FIG. 12 graphically illustrates, for a 6-tap interpolation filter, examples of loss versus Doppler frequency associated with different errors in estimating an AGC gain adjustment that occurs at the middle of the interpolation filter;

FIG. 13 graphically illustrates, for a 4-tap interpolation filter, examples of loss versus Doppler frequency associated with different errors in estimating an AGC gain adjustment that affects only one tap of the interpolation filter;

FIG. 14 graphically illustrates, for a 6-tap interpolation filter, examples of loss versus Doppler frequency associated with different errors in estimating an AGC gain adjustment that affects only two taps of the interpolation filter; and

FIG. 15 diagrammatically illustrates a communication receiver apparatus that supports differential modulation, and wherein the digital baseband part cooperates with the AGC unit to control the timing of AGC gain adjustments, according to embodiments of the invention.

### DETAILED DESCRIPTION

For clarity of exposition, embodiments of the invention are described herein in conjunction with OFDM communication systems, such as DVB-H, DVB-T, Super Third generation (S3G) or Fourth generation (4G) systems, etc. However, as will be apparent to workers in the art, the principles of the invention can be applied to other communication systems as well.

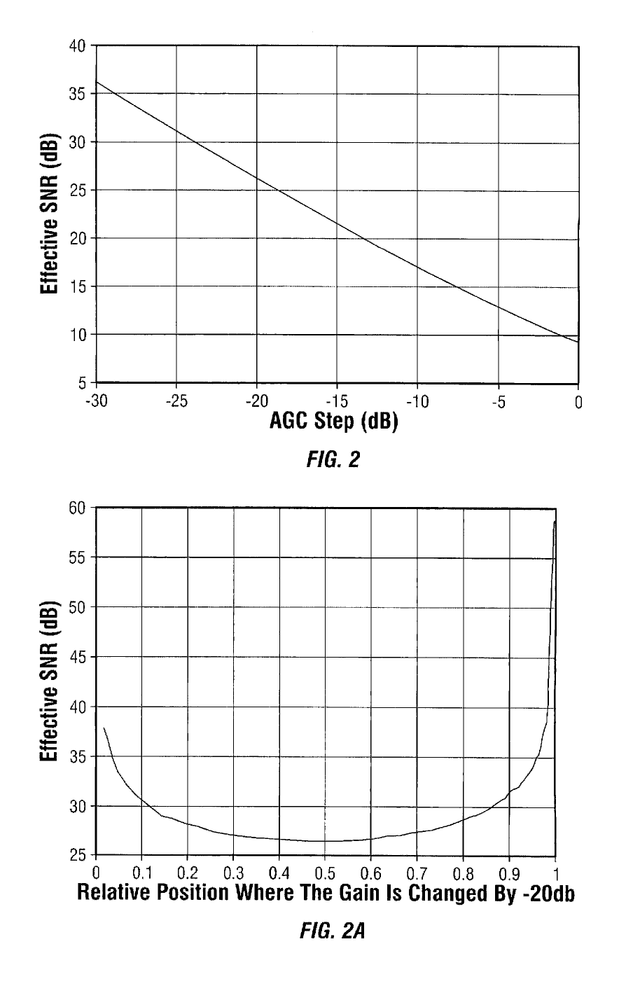

FIG. 2 graphically illustrates, for an OFDM system, the effective SNR (Signal to Noise Ratio) versus AGC gain adjustment step, where the gain adjustment step occurs at the midpoint of the OFDM symbol. Note that the AGC gain adjustment step shown in FIG. 2 is much smaller than what is commonplace in conventional AGC operation, which suggests that, for a realistic conventional step size, such as 1 decibel (dB), the performance degradation would be significant. To see the impact of an AGC step, consider FIG. 2 where the effective SNR versus the AGC gain adjustment step is shown. The effective SNR is for OFDM defined as signal power/(noise power+ICI). The denominator in the effective SNR is here entirely caused by ICI (inter-carrier interference) which is due to that a step in done in the AGC. No thermal noise has been added, so the effective SNR shown in this figure can be viewed as an upper limit for what can be obtained.

Referring to FIG. 2, where the step in the AGC is in the middle of the OFDM symbol, the following can be observed. If a step of the AGC is just −10 dB, the effective SNR cannot be larger than about 17 dB, even if there is no thermal noise and no other interference and/or noise present. For a more realistic step size, say in the order of 1 dB, the effective SNR cannot exceed 10 dB. For systems where high bandwidth efficiency is required, operating points of, say, 20 dB or above is commonplace. Clearly, then, an AGO step of typical size would completely ruin the performance and the system will be inoperable. It can be shown that the illustrated situation, where the gain adjustment step occurs at the midpoint of the OFDM system, is the worst case scenario.

In case of no noise and perfect orthogonality between the sub-carriers, the effective SNR would be infinitely large. Therefore, the effective SNR can in case of no noise be viewed as a measure of the orthogonality of the sub-carriers. Thus, a change of gain by the AGC during the part of the symbol that is used by the FFT in the OFDM receiver, such as the midpoint of the OFDM symbol, will cause a loss of orthogonality between the sub-carriers. This loss of orthogonality between subcarriers results in severe performance degradation due to ICI (Inter Carrier Interference).

As shown in FIG. 2A, performance improves only marginally when the AGC gain adjustment is not located exactly at the symbol midpoint (but performance is shown to be enough at the starting and endpoint of the symbol). It can further be shown that performance improves only marginally when the AGC gain adjustment is implemented as a ramp, instead of the step implementation associated with FIG. 2.

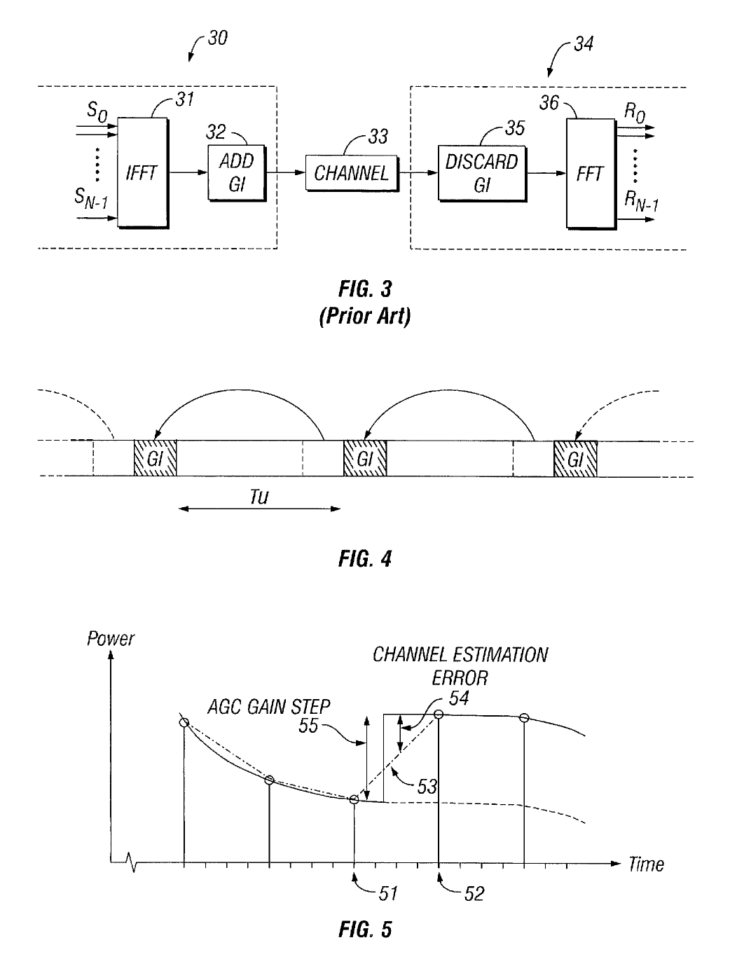

FIG. 3 diagrammatically illustrates a conventional OFDM communication system. In a transmitter 30 an inverse FFT (IFFT) unit 31 performs an IFFT operation on the outgoing symbols S (S₀-S_{N-1}, where N is the size of the IFFT/FFT) at 31. A guard interval (GI) portion 32 inserts guard intervals (also referred to as cyclic prefixes (CP)) into the signal that is transmitted on the channel 33. A receiver 34 discards the guard intervals from the received signals at 35 before an FFT unit 36 applies an FFT operation to produce received symbols R₀-R_{N-1}.

The relationship between guard intervals and information-carrying parts of a communication signal is illustrated generally in FIG. 4. The information carrying portions are of duration Tu. The GIs are inserted between the information-carrying portions. The arrows represent that information is copied in the GIs.

As mentioned above, the guard intervals in an OFDM system are discarded at the receiver in a baseband part, before applying the FFT operation. Therefore, if the AGC gain adjustment can be performed during the guard intervals, or in other parts of the signal that will be discarded or not used to carry substantive communication information, then problems related to loss of orthogonality, i.e. not reaching a high enough effective SNR, such as described in relation to FIGS. 2 and 2A can be avoided. The problems related to loss of orthogonality can generally be avoided by performing the AGC adjustment during any part of the signal that will be discarded or is not used to carry substantive communication information. According to embodiments of the invention, the analog AGC and the digital baseband of the receiver cooperate to control the timing of the AGC gain adjustments in a manner that avoids problems such as described above with respect to FIGS. 2 and 2A. Instead the effective SNR that may be achieved is much increased and the system will be able to operate as intended and performance may be enhanced.

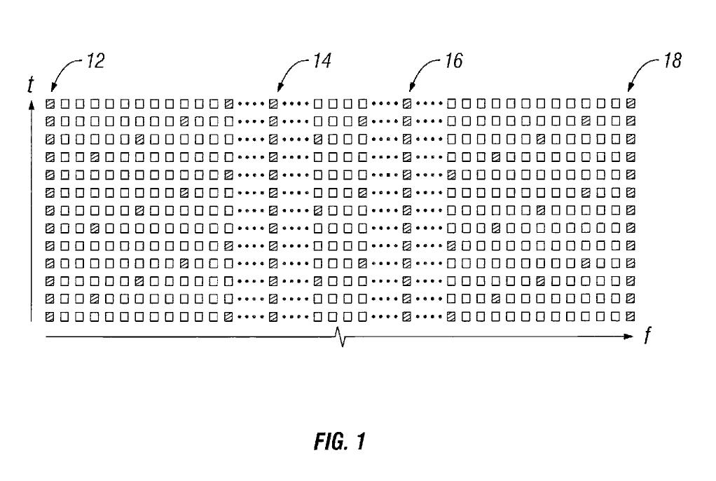

As mentioned above, some conventional channel estimation techniques use known pilot symbols that are relatively close to one another in time. In the OFDM system example of FIG. 1, on the frequencies that carry scattered pilot symbols, every fourth symbol is a pilot symbol. For each of these frequencies, the channel estimates for the symbol times that occur between two or more pilot symbols are obtained by using an interpolation filter included in or associated with the channel estimator to interpolate between the channel estimates obtained for the two or more pilot symbols. In systems that use this type of channel estimation technique, if an AGC gain adjustment occurs sometime between the two or more pilot symbols used for interpolation, then the channel estimation will deteriorate unless the gain adjustment can be compensated for in the baseband.

An example of how the estimation of the channel can deteriorate is illustrated graphically in FIG. 5. A channel estimation error occurs because the two pilot symbols (at times 51 and 52) between which the interpolation is performed have been subjected to respective gains that differ by the illustrated AGC gain step amount 55. This causes the erroneous interpolation shown at 53 in FIG. 5, which results in the illustrated channel estimation error 54.

In embodiments of the invention, the channel estimator in the baseband part of the receiver knows the size of the AGC gain step 55, and also knows when the gain step occurs, as will be described more below. Accordingly, the channel estimator can appropriately account for the gain step during the channel estimation process. In particular, embodiments of the invention scale the pilot symbols used for channel estimation by the reciprocal of the gain change. If the gain change is +/−X dB, then the pilot symbols that are subject to the gain change (e.g., at time 52 in FIG. 5) are scaled with −/+X dB compared to the pilot symbols received before the gain change. This permits the desired interpolation between pilot symbols to be performed as if no gain change has occurred. If the channel estimation is only using pilot symbols prior to the gain change (before time 51 of FIG. 5), then conventional channel estimation can be used without any modification. However, if the channel estimation is for a symbol between pilot symbol at time 51 and pilot symbol at time 52, then the channel estimate is scaled by the reciprocal of the gain change. For channel estimation after time 52 in FIG. 5, conventional channel estimation is again feasible because the AGC change then has no effect.

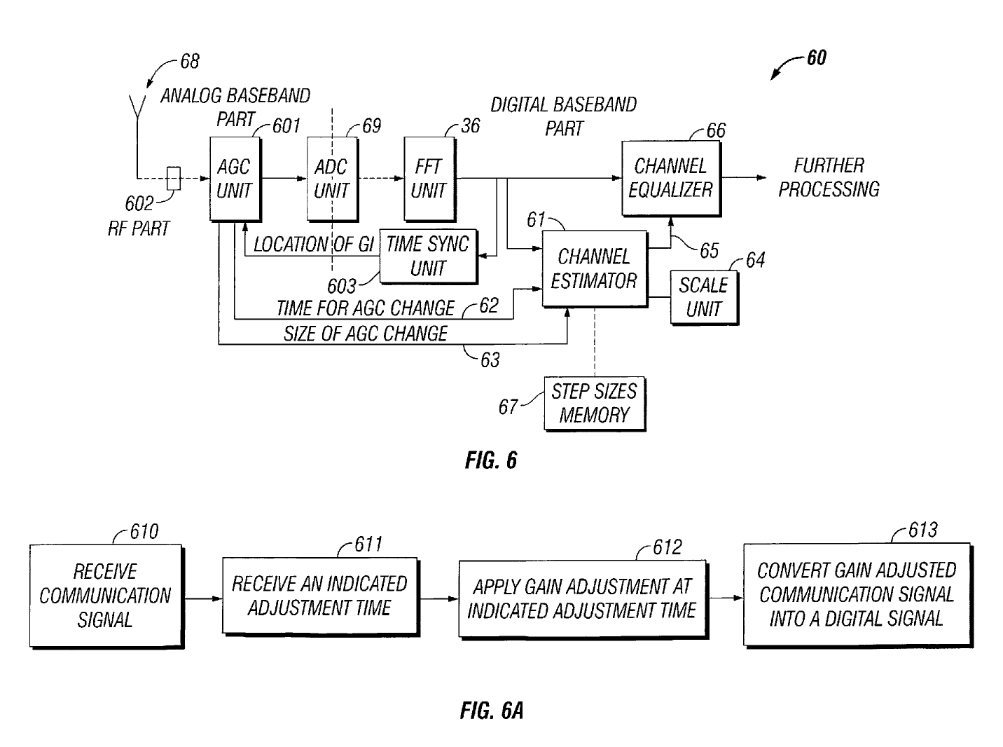

FIG. 6 diagrammatically illustrates a communication receiver apparatus 60 according to embodiments of the invention. The need for a gain change can be determined for example, in the digital baseband part, in the analog baseband part, or in an ADC unit 69. As shown in FIG. 6, a time sync unit 603 within the digital baseband part provides an AGC unit 601 with information indicative of the guard interval timing (see also FIG. 4), so the AGC unit 601 knows the time intervals during which it is permissible to implement a needed gain change. The AGC unit 601 applies a gain adjustment to a communication signal to produce a gain adjusted communication signal and the ADC unit 69 converts the gain adjusted communication signal to a digital signal, which in turns is further being processed in the digital baseband part by, for example, an FFT unit 36.

The input signal to the time sync unit may be the signal after the ADC unit 69 or after the FFT unit 36. The AGC unit 601 provides to the channel estimator 61 timing information 62 that indicates when the gain change will occur. This information is provided early enough for the channel estimator 61 to prepare for the gain change. In some embodiments, the timing information 62 is provided to the channel estimator 61 a few symbols before the actual gain change occurs. The AGC unit 601 also provides to the channel estimator 61 step size information 63 that indicates the size of the gain change. Given the timing information 62 and step size information 63, the channel estimator 61 can use a scaling unit 64 to scale the pilot symbols appropriately to account for the gain change, e.g., in the manner described above with respect to FIG. 5. The channel estimator 61 provides the channel estimate information 65 to a channel equalizer 66. The AGC unit 601 is also coupled to the radio frequency (RF) part 602 of the receiver which includes, for example, low noise amplifiers, down-conversion mixers, filters, etc. The RF part 602 is coupled to an antenna 68 that receives wireless signals.

In some embodiments, only the timing information 62 is provided to the channel estimator 61, and the step size information 63 is not provided. In such embodiments, the channel estimator 61 already knows all possible gain changes (step sizes stored in a memory unit 67 in FIG. 6) that the AGC unit 601 is permitted to implement, and so needs only to determine which of the possible gain changes has occurred. For example, if the AGC unit 601 is limited to a gain step size of 5 dB, then the channel estimator needs only to determine whether the gain change was +5 dB or −5 dB. In some embodiments, this is discovered by comparing the last pilot symbol before the gain change to the first pilot symbol after the gain change.

FIG. 6A is a flow chart illustrating, in general, the operational steps of embodiments of the present invention. In step 610, a communication signal is received from a communication channel on which a gain adjustment is to be applied using AGC to produce a gain adjusted communication signal. At step 611, an indication of an adjustment time is received. This time is when the digital baseband operation permits the gain adjustment. In step 612, in response to the indication, the gain adjustment is applied to the communication signal at the adjustment time. At step 613, the gain adjusted communication signal is converted into a digital signal for use in digital baseband operation.

Substantive communication information is presented during predetermined time intervals, and the adjustment time of step 612 is temporally distinct from the predetermined time intervals. Further, the adjustment time preferably is within a permitted adjustment time interval of the communication signal that is temporally distinct from the predetermined time intervals. The indication of step 611 preferably includes information that identifies a temporal location of the permitted adjustment time interval within the communication signal. The applying step 612 further may include the selection of the adjustment time from within the permitted adjustment time interval, wherein the permitted adjustment time interval is a guard interval. Alternatively, the adjustment time can be within a permitted adjustment time interval whose temporal location within the communication signal is identified by the indication, and may (i) further include providing digital baseband processing with timing information that specifies the adjustment time, and (ii) use digital baseband processing to estimate the communication channel based on the digital signal, the timing information, and size information indicative of a size of the gain adjustment. The immediately foregoing step may include (i) interpolating between pilot symbols represented by the digital signal to estimate the communication channel, including selecting among a plurality of available interpolation filters based on operating conditions; (ii) based on operating conditions, selecting one of the providing step and the using step to provide the size information.

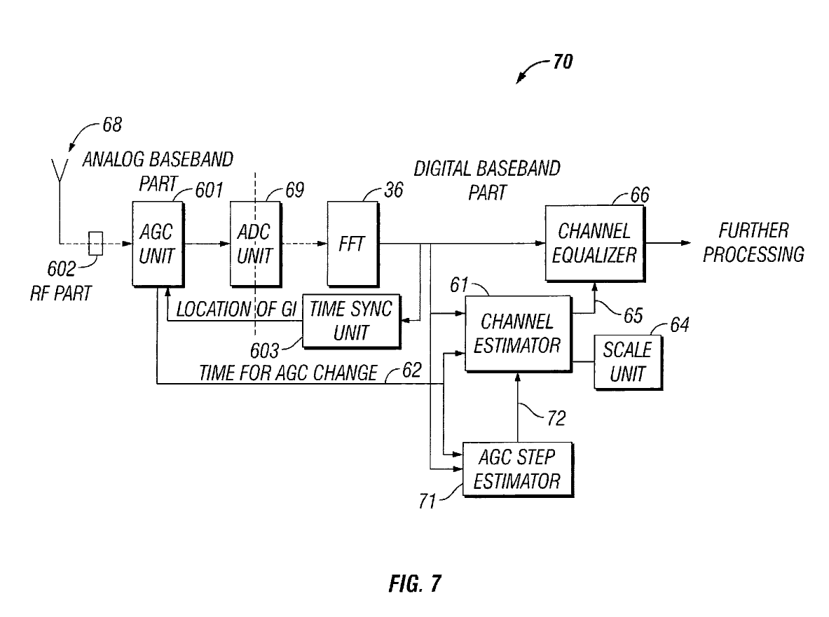

FIG. 7 diagrammatically illustrates a communication receiver apparatus 70 according to further embodiments of the invention. As compared to the receiver of FIG. 6, the receiver of FIG. 7 includes, in the digital baseband part, an additional estimator 71 that estimates the size of the gain step implemented by the AGC unit 601. This is useful in situations where the AGC unit 601 is not capable of conveying to the baseband part a sufficiently accurate indication (e.g., as shown at 63 in FIG. 6) of the size of the gain step that it actually does implement. Stated another way, the size of the gain step that actually comes into effect by the AGC operation does not match closely enough the gain step size that the AGC unit 601 conveys (e.g., at 63 in FIG. 6) to the baseband part. In such situations, the digital baseband part of the FIG. 7 receiver 70 estimates the gain step for itself, using the AGC step estimator 71. In some embodiments, the estimator 71 applies conventional techniques to continual pilot symbol sequences to estimate the gain change. Examples of such continual pilot symbol sequences are shown, for example, at 12, 14, 16, and 18 in FIG. 1. The AGC gain step estimator 71 provides the gain step estimate 72 to the channel estimator 61.

For clarity of exposition only, embodiments of the AGC step estimator 71 are described herein with respect to specific numerical examples from a DVB-H OFDM system (as described in for example, “ETSI EN 302 304 v1.1.1 (2004-11), Digital Video Broadcasting (DVB); Transmission System for Handheld Terminals (DVB-H)”). The specific examples below clearly do not, and are not intended to, limit the scope of the invention in any way. Other OFDM systems, such as Super third generation (S3G) or Fourth generation (4G) systems, may use the described embodiments.

For purposes of the expository examples, assume that: the periodically transmitted information-carrying part of the OFDM signal has a duration of Tu=896 μs (corresponding to an 8 k FFT and a bandwidth of 8 MHz); the length of the guard interval GI is Tu/4=224 μs; and the number of frequencies that carry continual pilot symbols (e.g., the number of frequencies such as those explicitly shown at 12, 14, 16, and 18 in FIG. 1) is 177.

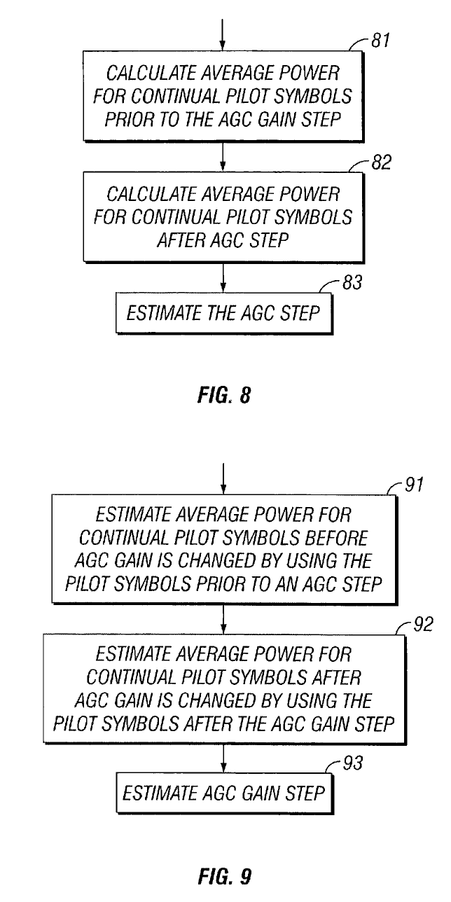

FIG. 8 illustrates operations, which can be performed in the digital baseband part to estimate the AGC gain step according to embodiments of the invention. In some embodiments, the estimator 71 of FIG. 7 is capable of performing the operations of FIG. 8. At 81, the average power P₀ of P continual pilot symbols Pₖ prior to the AGC gain step is calculated as:

$${P}_{0} = 20 {log}_{10} ( \frac{1}{P} {\sum }_{k = 1}^{P} \vert {p}_{k}^{( 0 )} \vert ) . \qquad ( 1 )$$

In Equation 1 above, P corresponds to the number of frequencies that carry continual pilot symbols (e.g., the number of frequencies such as those explicitly shown at 12, 14, 16 and 18 in FIG. 1). In the DVB-H example, P=177.

At 82, the average power P₁ of P continual pilot symbols after the AGC gain step is calculated as:

$${P}_{1} = 20 {log}_{10} ( \frac{1}{P} {\sum }_{k = 1}^{P} \vert {P}_{k}^{( 1 )} \vert ) . \qquad ( 2 )$$

At 83, the gain step size is estimated as the difference between the results of 81 and 82, step=P₁-P₀.

The operations of FIG. 8 assume that the channel is varying slowly enough for the (average) power to be essentially constant between two pilot symbols. Intuitively, this assumption would be expected to be valid for small Doppler frequencies, but not when the Doppler frequency is too large. Assuming a relatively small delay spread, the power of the continual pilot symbols can be expected to behave similarly from symbol to symbol in the time direction, i.e., either increasing or decreasing. On the other hand, if the delay spread is relatively large, then the power of the continual pilot symbols from symbol to symbol in the time direction can be expected to fluctuate more independently of one another. This implies that the expected value of the average change will be small, thus the estimate of the AGC step change can be expected to be more accurate.

FIG. 9 illustrates operations, which can be performed by the digital baseband part to estimate the AGC gain step according to further embodiments of the invention. In some embodiments, the estimator 71 of FIG. 7 is capable of performing the operations of FIG. 9. The operations in FIG. 9 take into account the channel variations on the different continual pilots. At 91, the average power P₀_{_{—}}′ for the continual pilot symbols before the AGC gain step is estimated by combining both the pilot symbols from Equation 1 above and the pilot symbols that immediately precede the pilot symbols from Equation 1, as:

$${P}_{{0}_{-}}^{′} = 20 {log}_{10} ( \frac{1}{P} {\sum }_{k = 1}^{P} \vert \frac{3}{2} {p}_{k}^{( 0 )} - \frac{1}{2} {p}_{k}^{( - 1 )} \vert ) . \qquad ( 3 )$$

At 92, the average power P₁_{_{—}}′ for the continual pilot symbols after the AGC gain step is estimated by combining both the pilot symbols from Equation 2 above and the pilot symbols that immediately follow the pilot symbols from Equation 2, as:

$${P}_{{1}_{-}}^{′} = 20 {log}_{10} ( \frac{1}{P} {\sum }_{k = 1}^{P} \vert \frac{3}{2} {p}_{k}^{( 1 )} - \frac{1}{2} {p}_{k}^{( 2 )} \vert ) . \qquad ( 4 )$$

At 93, the gain step size is estimated as the difference between the results of 91 and 92, step_′=P₁_{_{—}}′−P₀_{_{—}}′.

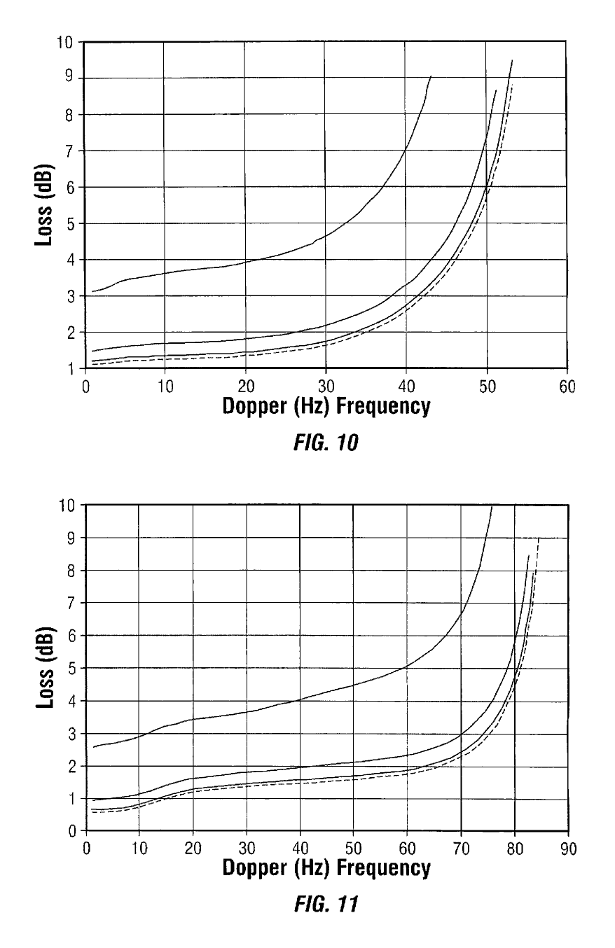

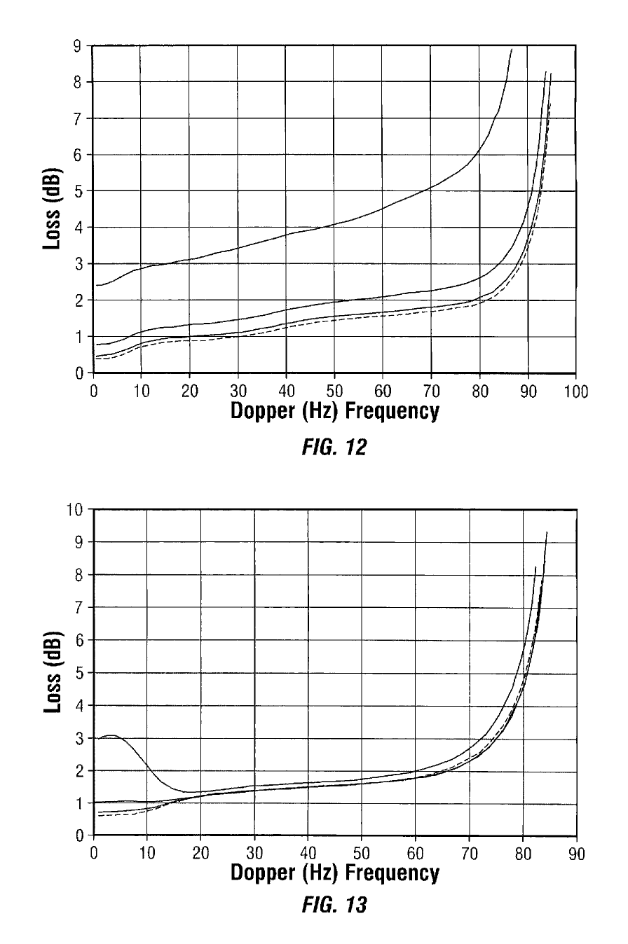

In embodiments where the gain step size is estimated in the digital baseband part, it can be beneficial to know how accurate the estimate should be. FIGS. 10-12 graphically illustrate examples of the loss versus Doppler frequencies for different estimation errors. The losses shown in FIGS. 10-12 are derived when the gain step occurs in the middle of the interpolation filter that performs interpolations between pilot symbols. Thus, for example, for a 6-tap interpolation filter, 3 of the taps will be affected by the erroneously estimated gain step size. FIGS. 10-12 each show loss curves for respective estimation errors of 0.0, 0.25, 0.5 and 1.0 dB, with a required SNR of 20 dB. FIGS. 10, 11, and 12 respectively correspond to 2, 4, and 6-tap interpolation filters.

Information like that shown in FIGS. 10-12 can also be used to determine whether the AGC is accurate enough, or whether to estimate the gain step in the baseband part. Referring to FIG. 10, it can be seen that the degradation caused by an AGC error of 0.25 dB is only around 0.1 dB. Therefore, if the AGC unit can be implemented with this accuracy there is no need to estimate the AGC step in the baseband part. On the other hand, if the accuracy of the AGC step in not better than 1 dB, the additional loss is 2 dB or more, and the performance can then be improved by estimating the step size in the baseband part.

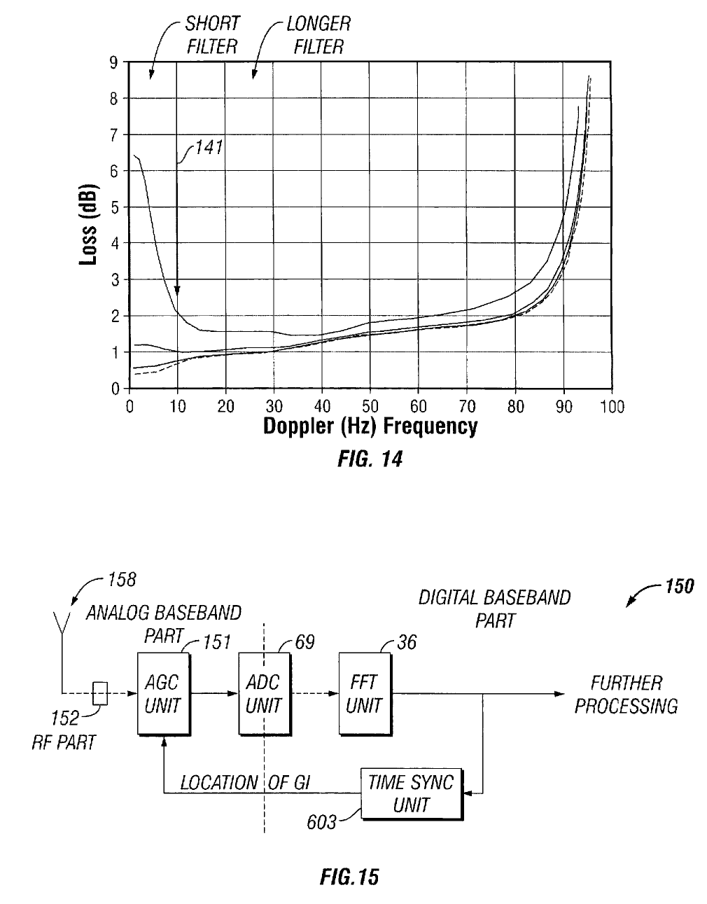

FIGS. 10-12 illustrate the worst case situation, where the gain step occurs in the middle of the interpolation filter. FIGS. 13 and 14 are similar to FIGS. 10-12, but the losses in the examples of FIGS. 13 and 14 are derived when the AGC gain step is not in the middle of the interpolation filter. FIGS. 13 and 14 each show loss curves for respective estimation errors of 0.0, 0.5, 1.0 and 2.0 dB, with a required SNR of 20 dB. In FIG. 13, the estimation errors affect 1 tap of a 4-tap filter, and in FIG. 14, the estimation errors affect 2 taps of a 6-tap filter. The impact of the estimation error is less, as would be expected. However, in FIGS. 13 and 14, the loss is rather large for low Doppler frequency, and then decreases with increasing Doppler frequency. This can be explained by recognizing that, at low Doppler frequency, the interpolation filter taps are more similar to one another in (absolute) value than at higher Doppler frequency. Accordingly, some embodiments use a short filter, e.g., only 2 taps, at low Doppler frequency (so that the gain step affects the interpolation during fewer symbols), and then switch to a longer filter at higher Doppler frequency. An example of a possible short-to-long filter switchover point is shown at 141 (around a Doppler frequency of 10 Hz) in FIG. 14. Some embodiments selectively change the interpolation filter to reduce the estimation error impact in problem areas such as the low Doppler frequency area, thereby moving toward optimal performance configurations.

The following observations have been formulated based on experimental simulation results.

In general, for SNRs of 20 dB or more, the estimation error is not due to noise, but is simply due to varying channel conditions.

The more frequency selective the channel (the larger the delay spread), the better the results, especially for the operations of FIG. 8. The larger the delay spread, the less the average (over frequency) power varies.

The larger the Doppler frequency, the more advantageous the operations of FIG. 9 become.

For a requirement of 1 dB estimation error accuracy and an SNR of 10 dB, the FIG. 9 operations perform acceptably. The FIG. 8 operations do not perform acceptably in the case of very low delay spread and high Doppler frequency.

For a requirement of 0.25 dB estimation error accuracy and an SNR of 20 dB, the performances of FIGS. 8 and 9 are degraded relative to the aforementioned 1 dB/10 dB example. FIG. 9 performs acceptably up to about 100 Hz Doppler frequency, while FIG. 8 performance becomes unacceptable at somewhat less than 100 Hz Doppler frequency.

For an estimation error accuracy requirement of 0.1 dB and an SNR of 30 dB, FIG. 8 performs acceptably only up to about 5 Hz Doppler frequency, while FIG. 9 performs acceptably up to about 50 Hz Doppler frequency.

FIG. 15 diagrammatically illustrates a communication receiver apparatus 150 according to further embodiments of the invention. The receiver 150 of FIG. 15 supports differential modulation, a technique wherein the communication information is determined based on the difference between two symbols. With differential modulation, channel estimation and channel equalization are not needed, because the differences between differentially modulated symbols will be generally independent of channel variations. The receiver 150 includes an antenna 158 and an RF part 152 suitable for supporting differential modulation. An AGC unit 151 in the analog baseband part receives from a time sync unit 603 in the digital baseband part information that identifies the temporal location of the guard intervals within the received communication signal. The AGC unit 151 then knows that it is permissible to adjust the gain during the guard intervals as specified by the time sync unit 603, and performs gain adjustments at adjustment times selected from within the guard intervals. As indicated above, in various embodiments, the time sync unit 603 provides to the AGC unit 151 information that identifies the temporal locations of various parts of the received communication signal that will be discarded or are not used to carry substantive communication information. The input signal to the time sync unit may be the signal after the ADC unit 69 or after the FFT unit 36. The AGC unit 151 then knows that it is permissible to adjust the gain during the part(s) of the received communication signal specified by the time sync unit 603, and performs gain adjustments at adjustment times selected from within the part(s) specified by the time sync unit 603. The ADC unit 69 and FFT unit 36 in FIG. 15 operate in the same fashion as described above.

As demonstrated above, the principles of the present invention are applicable to wireless communication receivers, for example, mobile receivers such as mobile telephones, pagers, personal digital assistants, and others. As also demonstrated above, various embodiments of the invention can be implemented in hardware, software, or a combination of hardware and software.

Although embodiments of the invention have been described above in detail, this does not limit the scope of the invention, which can be practiced in a variety of embodiments.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. An apparatus for use in a communication receiver, comprising:
an input for receiving a communication signal from a communication channel;
an automatic gain control (AGC) apparatus coupled to the input and configured to apply a gain adjustment to the communication signal to produce a gain adjusted communication signal;
an analog-to-digital converter (ADC) coupled to the AGC apparatus for converting the gain adjusted communication signal into a digital signal; and
a digital baseband part coupled to receive the digital signal from the ADC, the AGC apparatus coupled to the digital baseband part and configured to receive from the digital baseband part an indication of an adjustment time at which the gain adjustment is permitted, and the AGC apparatus configured to apply the gain adjustment to the communication signal at the adjustment time in response to the indication.

2. The apparatus of claim 1, wherein the communication signal presents substantive communication information during predetermined time intervals, and the adjustment time is temporally distinct from the predetermined time intervals.

3. The apparatus of claim 2, wherein the adjustment time is within a permitted adjustment time interval of the communication signal that is temporally distinct from the predetermined time intervals, wherein the indication includes information that identifies a temporal location of the permitted adjustment time interval within the communication signal, and wherein the AGC apparatus is configured to select the adjustment time from within the permitted adjustment time interval.

4. The apparatus of claim 3, wherein the permitted adjustment time interval is a time interval where part of the communication signal may be discarded or not used to carry substantive communication information; and the permitted adjustment time interval is located between symbols in an Orthogonal Frequency Division Multiple access system.

5. The apparatus of claim 1, wherein the adjustment time is within a permitted adjustment time interval whose temporal location within the communication signal is identified by the indication, the digital baseband part including a channel estimator configured to receive from the AGC apparatus timing information that specifies the adjustment time, the channel estimator configured to estimate the communication channel based on the digital signal, the timing information, and size information indicative of a size of the gain adjustment.

6. The apparatus of claim 5, wherein the channel estimator is configured to produce an estimate of the communication channel that has been scaled based on the size information.

7. The apparatus of claim 5, wherein the channel estimator is configured to receive the size information from the AGC apparatus.

8. The apparatus of claim 5, wherein the channel estimator is configured to interpolate between pilot symbols represented in the digital signal to estimate the communication channel.

9. The apparatus of claim 5, including a gain adjustment size estimator provided in the digital baseband part, wherein the gain adjustment size estimator is configured to calculate a first power associated with a first group of pilot symbols represented in the digital signal and a second power associated with a second group of pilot symbols represented in the digital signal, and to compare the first power and the second power to produce the size information, and wherein the first and second groups of pilot symbols occur before and after the gain adjustment, respectively.

10. The apparatus of claim 9, wherein each of the groups of pilot symbols is within a separate symbol in an Orthogonal Frequency Division Multiple access system.

11. The apparatus of claim 5, including a gain adjustment size estimator provided in the digital baseband part, wherein the gain adjustment size estimator is configured to use first and second groups of pilot symbols represented in the digital signal to calculate first power associated with a time before the gain adjustment, to use third and fourth groups of pilot symbols represented in the digital signal to calculate second power associated with a time after the gain adjustment, and to compare the first power and the second power to produce the size information, and wherein the first and second groups of pilot symbols occur before the gain adjustment and the third and fourth groups of pilot symbols occur after the gain adjustment.

12. The apparatus of claim 5, wherein the digital baseband part is configured to produce the size information by selecting from a set of predetermined gain adjustment size values.

13. The apparatus of claim 5, wherein the communication signal presents substantive communication information during predetermined time intervals, and the permitted adjustment time interval is temporally distinct from the predetermined time intervals.

14. The apparatus of claim 5, wherein the permitted adjustment time interval is a time interval where part of the communication signal may be discarded or not used to carry substantive communication information; and the permitted adjustment time interval is located between symbols in an Orthogonal Frequency Division Multiple access system.

15. An apparatus for use in a communication receiver, comprising:
an input for receiving a communication signal from a communication channel;
an automatic gain control (AGC) apparatus coupled to the input and configured to apply a gain adjustment to the communication signal to produce a gain adjusted communication signal;
an analog-to-digital converter (ADC) coupled to the AGC apparatus for converting the gain adjusted communication signal into a digital signal; and
a digital baseband part coupled to receive the digital signal from the ADC, the digital baseband part including a channel estimator coupled to receive from the AGC apparatus timing information indicative of when the gain adjustment occurs, the channel estimator configured to estimate the communication channel based on the digital signal, the timing information, and size information indicative of a size of the gain adjustment.

16. The apparatus of claim 15, provided as an Orthogonal Frequency Division Multiplexing, OFDM, apparatus.

17. A method for use in a communication receiver, comprising:
receiving a communication signal from a communication channel;
using automatic gain control (AGC) to apply a gain adjustment to the communication signal to produce a gain adjusted communication signal;
receiving an indication of an adjustment time at which digital baseband operation permits the gain adjustment, and, in response to the indication, applying the gain adjustment to the communication signal at the adjustment time; and
converting the gain adjusted communication signal into a digital signal for use in digital baseband operation.

18. The method of claim 17, wherein the communication signal presents substantive communication information during predetermined time intervals, and the adjustment time is temporally distinct from the predetermined time intervals.

19. The method of claim 18, wherein the adjustment time is within a permitted adjustment time interval of the communication signal that is temporally distinct from the predetermined time intervals, wherein the indication includes information that identifies a temporal location of the permitted adjustment time interval within the communication signal, and wherein the applying step includes selecting the adjustment time from within the permitted adjustment time interval.

20. The method of claim 19, wherein the permitted adjustment time interval is a time interval where part of the communication signal may be discarded or not used to carry substantive communication information; and the permitted adjustment time interval is located between symbols in an Orthogonal Frequency Division Multiple access system.

21. The method of claim 17, wherein the adjustment time is within a permitted adjustment time interval whose temporal location within the communication signal is identified by the indication, and including providing digital baseband processing with timing information that specifies the adjustment time, and using digital baseband processing to estimate the communication channel based on the digital signal, the timing information, and size information indicative of a size of the gain adjustment.

22. The method of claim 21, wherein the last-mentioned using step includes interpolating between pilot symbols represented by the digital signal to estimate the communication channel, the interpolating step including selecting among a plurality of available interpolation filters based on operating conditions.

23. The method of claim 21, including, based on operating conditions, selecting one of the providing step and the last-mentioned using step to provide the size information.

24. The method of claim 21, including using digital baseband processing to produce the size information according to one of a plurality of available processes, and selecting one of the processes based on operating conditions.

25. The method of claim 21, wherein the last-mentioned using step includes producing an estimate of the communication channel that has been scaled based on the size information.

26. The method of claim 21, wherein the communication signal presents substantive communication information during predetermined time intervals, and the permitted adjustment time interval is temporally distinct from the predetermined time intervals.

27. The method of claim 21, wherein the last-mentioned using step includes using first and second groups of pilot symbols represented in the digital signal to calculate first power associated with a time before the gain adjustment, using third and fourth groups of pilot symbols represented in the digital signal to calculate second power associated with a time after the gain adjustment, and comparing the first power and the second power to produce the size information, and wherein the first and second groups of pilot symbols occur before the gain adjustment and the third and fourth groups of pilot symbols occur after the gain adjustment.

28. The method of claim 21, wherein the permitted adjustment time interval is a time interval where part of the communication signal may be discarded or not used to carry substantive communication information; and the permitted adjustment time interval is located between symbols in an Orthogonal Frequency Division Multiple access system.

29. A method for use in a communication receiver, comprising:
receiving a communication signal from a communication channel;
using automatic gain control (AGC) to apply a gain adjustment to the communication signal to produce a gain adjusted communication signal;
providing timing information indicative of when the gain adjustment occurs;
converting the gain adjusted communication signal into a digital signal; and
using digital baseband processing to estimate the communication channel based on the digital signal, the timing information, and size information indicative of a size of the gain adjustment.

30. The method of claim 29, for use in an Orthogonal Frequency Division Multiplexing, OFDM, receiver.

31. The method of claim 29, wherein each of the groups of pilot symbols is within a separate symbol in an Orthogonal Frequency Division Multiple access system.
